(19) United States
(12) Patent Application Publication
(10) Pub. No.: US 2004/0167650 A1
(43) Pub. Date: Aug. 26, 2004

(54) Partial reprojection method and device in three-dimensional CAD system and computer program

(75) Inventor: Masahito Nasu, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kanagawa (JP)

(21) Appl. No.: 10/763,191

(22) Filed: Jan. 26, 2004

(30) Foreign Application Priority Data
Feb. 21, 2003 (JP) 2003-044674

(51) Int. Cl. G06F 19/00

(52) U.S. Cl. 700/98

(57) ABSTRACT

A partial reprojection device includes a reprojection processing portion for controlling a partial reprojection process, a modeling kernel for performing a contour line process, a hidden line process and other processes. The reprojection processing portion includes an associative analysis processing portion for analyzing information of two-dimensional projection to be a reprojection target, a drawing processing portion for deciding a three-dimensional element to be a projection target from three-dimensional shape data and a projection condition in association with the modeling kernel, a drawing data generation processing portion for generating the decided three-dimensional element as a two-dimensional element on the drawing, and an associative setting processing portion for grouping the generated two-dimensional elements for each part and for setting a relationship with various conditions and the models.

### BACKGROUND OF THE INVENTION

1. Field of the Invention

The present invention relates to a partial reprojection method in a three-dimensional CAD system. More specifically, the present invention relates to a partial reprojection method, a device and a computer program for reflecting a shape modified in a part model on a two-dimensional projection generated from an assembly model.

2. Description of the Prior Art

A three-dimensional CAD (computer aided design) system has some advantages that a shape can be recognized easily or design errors can be found at early stage using an interference check. Therefore, the three-dimensional CAD has been becoming a mainstream of a CAD system. However, for a real machine process or formation of a model, two-dimensional drawings are still necessary in many cases. In addition, there may be another problem that information that can be expressed in the conventional two-dimensional CAD data cannot be expressed in the three-dimensional CAD data. For this reason, many three-dimensional CAD systems have a function of projecting a three-dimensional model onto a two-dimensional drawing for generating an assembly drawing of the entire product or drawings of parts. Such projection process from a three-dimensional model onto a two-dimensional drawing is described in Japanese unexamined patent publications No. 7-334534 and No. 11-203331.

There are two methods for generating a two-dimensional part drawing from a three-dimensional model. In a first method, a three-dimensional model of a designated part (i.e., a part model) is loaded and is projected onto a two-dimensional drawing. In a second method, a two-dimensional projection drawing of a designated part is generated directly from a three-dimensional model of the entire product (an assembly model) in which plural parts are combined. The second method is used more often in the case where the product is made of many parts since plural part drawings can be generated at the same time without loading and projecting each part model for each part.

FIG. 1 shows an example where a two-dimensional projection drawing is generated from an assembly model in the conventional three-dimensional CAD system. In this example, the assembly model includes two parts P1 and P2, which can be projected respectively onto two layers of a two-dimensional drawing generated from the assembly model at one time. The projection of each part is generated in accordance with a position and a posture of the part in the coordinates of the assembly model. The generated two-dimensional drawing can be regarded as drawings of parts when viewed by each layer and as an assembly drawing when viewed by all layers in an overlaying manner. The part drawing of each layer can be an individual file for output.

In addition, a three-dimensional CAD system has a function of reflecting a modification of a shape or others in a three-dimensional model on a two-dimensional projection drawing that was generated from the three-dimensional model at any timing. This function is called a reprojection. For this reprojection, it is required to load a three-dimensional model (a part model or an assembly model) that was used for generating the two-dimensional projection so as to reflect a shape of the model.

For example, in a three-dimensional model of an assembly ASM including parts P1 and P2 as shown in FIG. 2, if the projection of the part P1 is generated from three directions (lines of sight) V1, V2 and V3, a two-dimensional projection drawing as shown in FIG. 3 is obtained. In this case, a front view, a top view and a right side view retain attribution data A1, A2 and A3, respectively. Each of the attribution data A1, A2 and A3 includes a load model ASM, a projection target model P1 and information about the line of sight V1, V2 or V3. In this case, the three-dimensional model that can be reprojected directly by modifying a shape is the load model ASM.

In a so-called top-down design, it is often carried out to generate a two-dimensional drawing of each part (a part drawing) from the three-dimensional model of the assembly generated in a concept design and to proceed a detail design using a three-dimensional model of each part (a part model) and a part drawing. As explained above, when the number of parts increases, it is time-consuming and burdensome to load a part model of each part for projecting a part drawing. Therefore, the method is often adopted in which part drawings of parts are generated from the three-dimensional model of the assembly at one time. In addition, there can be different designers for different parts in many cases, where a designer for a detail design cannot always use all three-dimensional models (assembly models and part models).

When making a modification using a three-dimensional model of a part in the detail design, a three-dimensional model that was used for generating the part drawing, i.e., an assembly model retaining information of a position and a posture of the part is necessary for reflecting the modification on a part drawing as explained above. However, as explained above, only a part model and a part drawing can be used in the detail design stage in many cases. Therefore, in these cases, the shape modified in the detail design by using a part model cannot be reflected on the part drawing generated in a concept designing stage. Accordingly, a part drawing should be newly projected with the position and the posture adapted to the part drawing generated in the concept designing stage. However, if the projection is generated newly from the part model, a reprojection from the assembly model cannot be done.

### SUMMARY OF THE INVENTION

An object of the present invention is to make it possible to reflect a modified shape in a three-dimensional model on a part drawing generated from an assembly model without loading the assembly model while retaining a position and a posture of the part drawing.

According to one aspect of the present invention, a partial reprojection method is provided for reflecting a shape modified in a part model on a two-dimensional projection that is generated from an assembly model in a three-dimensional CAD system. The method includes the steps of grouping elements projected from the assembly model for each part, adding attributions of each part information, the attributions including a line of sight and a position of the part to the two-dimensional projection, and specifying two-dimensional elements to be updated when updating the shape in the part model, so as to decide a projecting direction of the part model from the line of sight of each part included in the part information and to decide a generating position of the two-dimensional elements from the position of the part included in the part information.

Since a relationship between the coordinates of the assembly model and the coordinates of the part model, i.e., a projecting direction and a relative position of the part model in the coordinates of the assembly model is specified from the part information that is added as attributions, consistency between them can be secured easily.

In a preferred embodiment, the partial reprojection method further comprises the steps of adding attributions of projection information to the two-dimensional projection, the attributions including information about a loaded model and information about a model to be projected, and deciding whether the entire reprojection is performed from the assembly model or a partial reprojection is performed for a part in accordance with the projection information. if the partial reprojection is performed, the attributions of the part information and the projection information are not changed but only the shape is changed.

According to this structure, when modifying and updating a part drawing generated by projecting a three-dimensional model, modification of all models are reflected on the projection if the model that was used for generating the projection is loaded, while only the shape can be reflected without loading the model that was used for generating the projection if a part of the models is loaded.

Therefore, in a top-down design for example, it will be sufficient to pass minimum data in each stage from a concept design via a detail design through a whole check. In addition, if a CAD system is used together with a data management tool, it is sufficient to extract only a part model and a part drawing from the data management tool when changing a shape of a part. Therefore, it is not required to extract an unnecessary model tool.

Furthermore, a partial reprojection device according to the present invention is for reflecting a shape modified in a part model on a two-dimensional projection that is generated from an assembly model in a three-dimensional CAD system. The device includes a reprojection processing portion for controlling a partial reprojection process and a modeling kernel for performing processes including a contour line process and a hidden line process. The reprojection processing portion includes an associative analysis processing portion for analyzing information of the two-dimensional projection to be reprojected, a drawing processing portion for deciding three-dimensional elements to be projected in association with the modeling kernel from three-dimensional shape data and a projection condition, a drawing data generation processing portion for generating the decided three-dimensional elements as two-dimensional elements on the drawing, and an associative setting processing portion for grouping the generated two-dimensional elements for each part and for setting a relationship with conditions and the models.

In addition, a computer program product according to the present invention is for use in a three-dimensional CAD system for enabling reflection of a shape modified in a part model on a two-dimensional projection generated from an assembly model. The computer program product includes means for grouping elements projected from the assembly model for each part, means for adding attributions of each part information to the two-dimensional projection, the attributions including a line of sight and a position of the part, and means for specifying two-dimensional elements to be updated when updating the shape in the part model, so as to decide a projecting direction of the part model from the line of sight of each part included in the part information and to decide a generating position of the two-dimensional elements from the position of the part included in the part information.

According to this structure, since a relationship between the coordinates of the assembly model and the coordinates of the part model, i.e., a projecting direction and a relative position of the part model in the coordinates of the assembly model is specified from the part information that is added as attributions, consistency between them can be secured easily.

In the preferred embodiment, the computer program product further includes means for adding attributions of projection information to the two-dimensional projection, the attributions including information about a loaded model and information about a model to be projected, means for deciding whether the entire reprojection is performed from the assembly model or a partial reprojection is performed for a part in accordance with the projection information, and means for changing only the shape without changing the attributions of the part information and the projection information when performing the partial reprojection.

According to this structure, when modifying and updating a part drawing generated by projecting a three-dimensional model, modification of all models are reflected on the projection if the model that was used for generating the projection is loaded, while only the shape can be reflected without loading the model that was used for generating the projection if a part of the models is loaded.

In addition, a recording medium that can be read by a computer according to the present invention stores a computer program for a three-dimensional CAD system that enables reflection of a shape modified in a part model on a two-dimensional projection generated from an assembly model. The computer program makes a computer perform the process including the steps of grouping elements projected from the assembly model for each part, adding attributions of each part information to the two-dimensional projection, the attributions including a line of sight and a position of the part, and specifying two-dimensional elements to be updated when updating the shape in the part model, so as to decide a projecting direction of the part model from the line of sight of each part included in the part information and to decide a generating position of the two-dimensional elements from the position of the part included in the part information.

In the preferred embodiment, the process performed by the computer further includes the steps of adding attributions of projection information to the two-dimensional projection, the attributions including information about a loaded model and information about a model to be projected, deciding whether the entire reprojection is performed from the assembly model or a partial reprojection is performed for a part in accordance with the projection information, and changing only the shape without changing the attributions of the part information and the projection information when performing the partial reprojection.

### BRIEF DESCRIPTION OF THE DRAWINGS

FIG. 1 shows an example where a two-dimensional projection drawing is generated from an assembly model in the conventional three-dimensional CAD system.

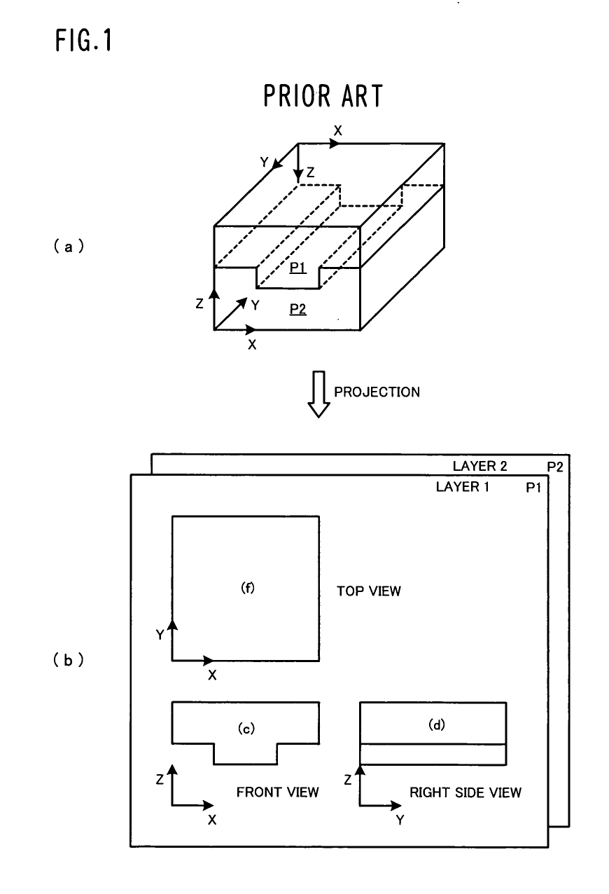

FIG. 2 shows an example of an assembly model in the conventional three-dimensional CAD system.

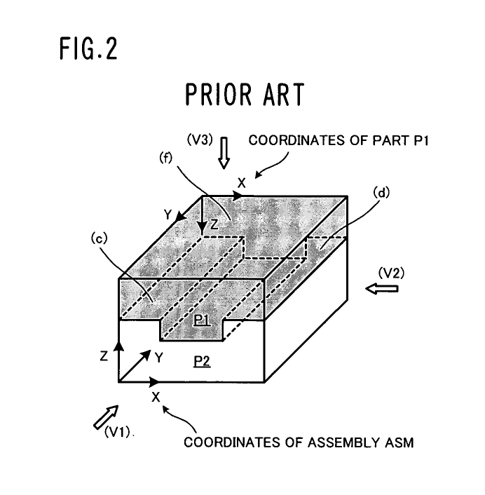

FIG. 3 shows an example of attribution data of two-dimensional projection in the conventional three-dimensional CAD system.

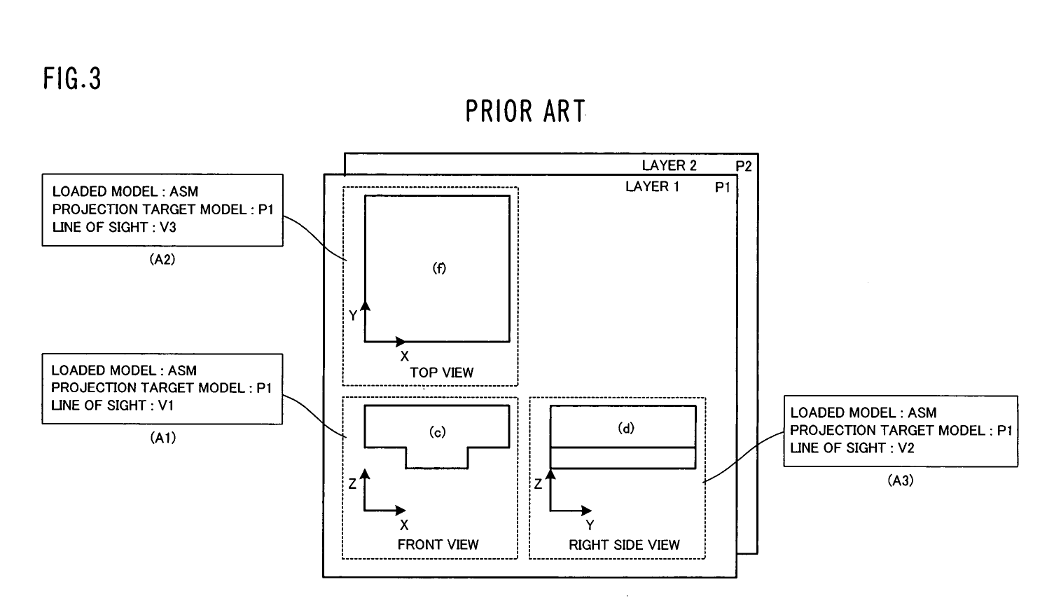

FIG. 4 shows reflection of a shape modification in a three-dimensional model on a part drawing generated from an assembly model.

FIG. 5 is an explanatory diagram of part information for enabling a partial reprojection.

FIG. 6 is a block diagram showing a structure of a CAD system according to an embodiment of the present invention.

FIG. 7 is a flowchart showing an operation of a partial reprojection device.

FIG. 8 shows an example of part information and projection information that are added to a projection drawing after a reprojection.

### DESCRIPTION OF THE PREFERRED EMBODIMENTS

Hereinafter, the present invention will be explained more in detail with reference to embodiments and drawings.

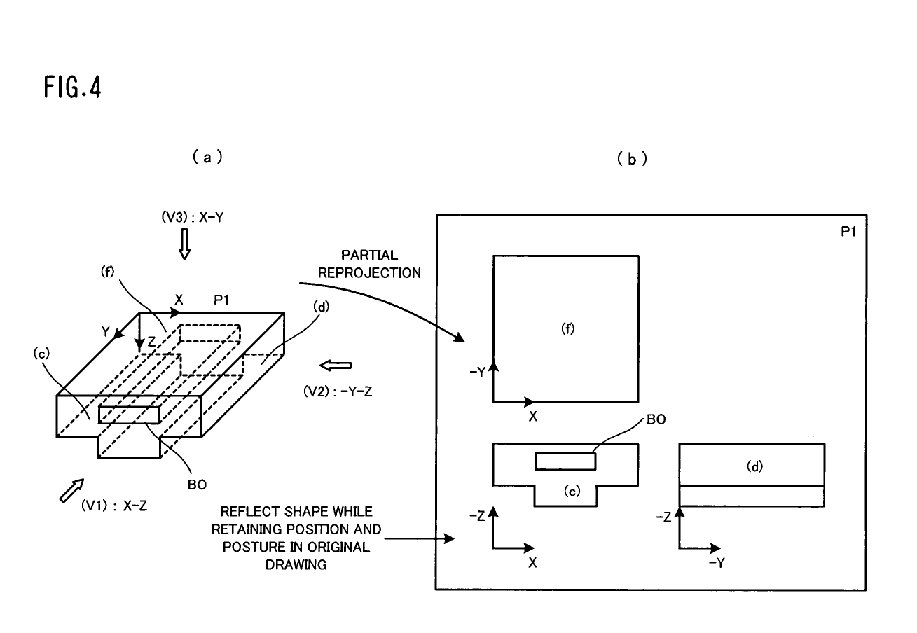

FIG. 4 shows reflection of a shape modification in a three-dimensional model on a part drawing generated from an assembly model. In this example as shown in FIG. 4, when a through hole BO is added to a part model (a three-dimensional model) as shown in (a), the through hole BO is reflected on a part drawing (a projection from an assembly model) while retaining a position and a posture in the original drawing for projection as shown in (b). In other words, the modification in the part model can be projected on the part drawing generated from the assembly model (i.e., a partial reprojection).

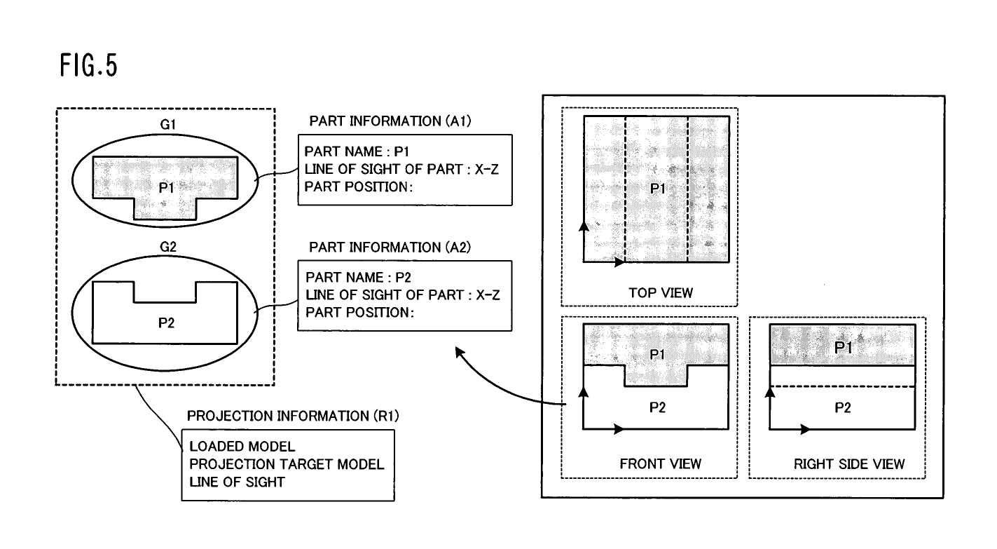

FIG. 5 is an explanatory diagram of part information for enabling the above-mentioned partial reprojection. The partial reprojection method and device according to the present invention in a three-dimensional CAD system performs grouping of projected elements (e.g., lines) for each part to make a group G1 or G2, and adds part information A1 or A2 about a line of sight for each part and a part position as attributions. In this way, when updating a shape of a single part, a two-dimensional element to be a target of the update is specified. A projecting direction of the part model P1 or P2 is decided from the line of sight for each part that is added as the attribution, and a position of generating the two-dimensional element is decided from a position attribution.

In addition, a state of the model (information of the loaded model) and information of the projected model when the projection is generated, i.e., information about the model selected as a projection target and the model that was really projected is added as projection information R1 to the projection drawing. Thus, it is decided whether a conventional reprojection is performed (i.e., the entire reprojection is updated) or only a shape of a part in the projection is reprojected (a partial reprojection is performed).

Furthermore, in order to enable the reprojection from an original model state when only a shape of a part in the projection is reprojected, only the shape is updated without changing information that is added to the projection when performing the partial reprojection.

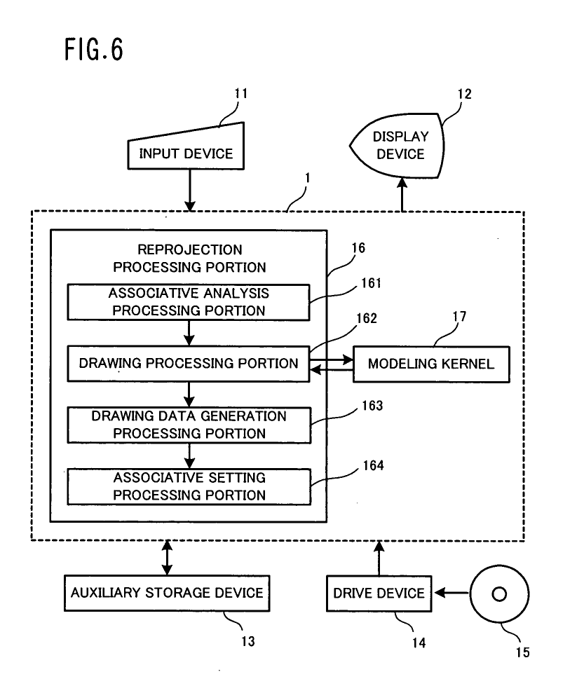

FIG. 6 is a block diagram showing a structure of a CAD system according to an embodiment of the present invention. This CAD system can be structured by installing a computer program (software) for CAD in a computer system such as a personal computer. The computer system includes a CPU, a main memory, an input device 11 such as a keyboard or a mouse, a display device 12 for a CRT or an LCD, an auxiliary storage device 13 such as a hard disk drive and a drive device 14 for a removable storage medium.

The CAD program that constitutes the CAD system according to the present invention is recorded in a removable recording medium 15 such as a CD-ROM (an optical storage disk) for distribution and is installed in the auxiliary storage device 13 through the drive device 14. The CAD program installed in the auxiliary storage device 13 is loaded into the main memory to be executed by the CPU. In the structure as shown in FIG. 6, the CPU and the main memory (the CAD program loaded into the main memory) constitute the CAD system mainly, and a portion relevant to the partial reprojection process is shown as a partial reprojection device 1 including functional blocks.

The partial reprojection device 1 includes a reprojection processing portion 16 for controlling a partial reprojection process and a modeling kernel 17 for performing a contour line process, a hidden line process and other processes (information about contour lines, hidden lines and others is returned). In addition, the input device 11 is used for designating a condition for performing the reprojection process. The auxiliary storage device 13 stores CAD data of two-dimensional drawings and three-dimensional models in addition to the CAD program.

The reprojection processing portion 16 includes an associative analysis processing portion 161 for analyzing information of the projection drawing to be a target of the reprojection, a drawing processing portion 162 for deciding a three-dimensional element to be a target of the projection from three-dimensional shape data and a projection condition in association with the modeling kernel 17, a drawing data generation processing portion 163 for generating the decided three-dimensional element as a two-dimensional element on the drawing, and an associative setting processing portion 164 for grouping the generated two-dimensional elements for each part and for setting a relationship with various conditions and the models.

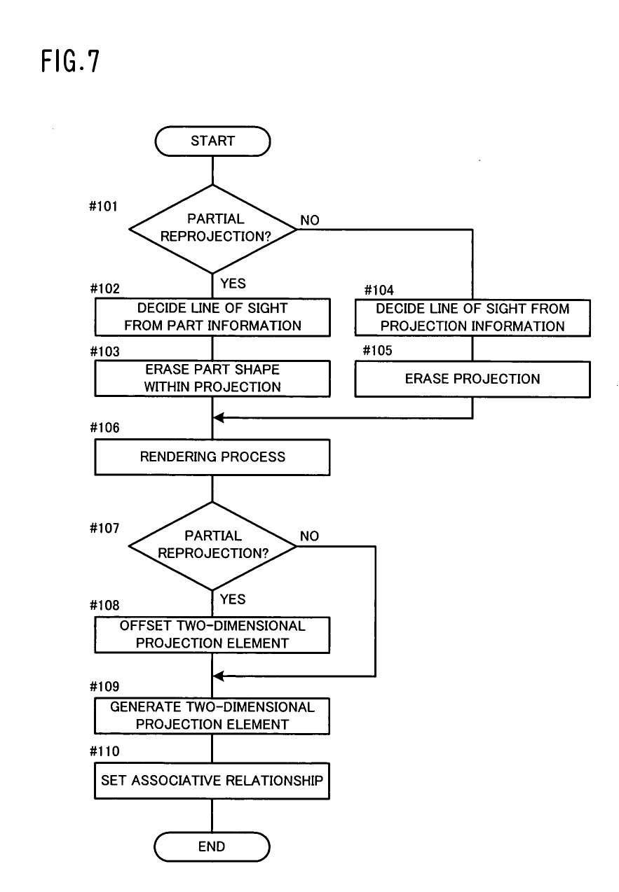

FIG. 7 is a flowchart showing an operation of a partial reprojection device 1. In Step #101, the associative analysis processing portion 161 checks whether or not the partial reprojection is performed. Namely, projection information is obtained from the drawing data and the model data stored in the auxiliary storage device 13, and it is checked whether or not a partial model within the projection drawing is a target of the reprojection (it means the partial reprojection).

Then, if it is the partial reprojection, the partial reprojection process is performed in Step #102 and Step #103. Otherwise, the normal reprojection is performed in Step #104 and Step #105. Furthermore, the user may use the input device 11 for designating either the normal reprojection or the partial reprojection in accordance with the user's operating form.

In Step #102 that is performed in the case of the partial reprojection, a line of sight of a single part is decided from the part information within the projection (denoted by A1 and A2 in FIG. 5). In the subsequent Step #103, only the projection shape of the part is erased. After that, the process goes to Step #106 for a rendering process.

In the case where it is not the partial reprojection, i.e., the model from which the projection was generated is the reprojection target, a line of sight of the model is decided from the projection information (denoted by R1 in FIG. 5) in Step #104. In the next Step #105, the entire projection is erased. Namely, after performing the normal (conventional) reprojection process, the process goes to Step #106 for the rendering process.

In Step #106, the drawing processing portion 162 performs the rendering process. Namely, the line of sight decided in Step #102 or Step #104, the three-dimensional shape data and the projection condition designated by the input device are passed to the modeling kernel 17 so that three-dimensional information of contour lines and hidden lines is obtained.

It is checked whether or not it is the partial reprojection in the next Step #107. If it is the partial reprojection, an offset of the two-dimensional projection element is performed in Step #108. Namely, the drawing data generation processing portion 163 obtains a position in each line of sight from a position of a part included in the part information. Responding to the result, the data obtained in the rendering process in Step #106 is offset. In accordance with the result, the projection of the target drawing is generated in Step #109.

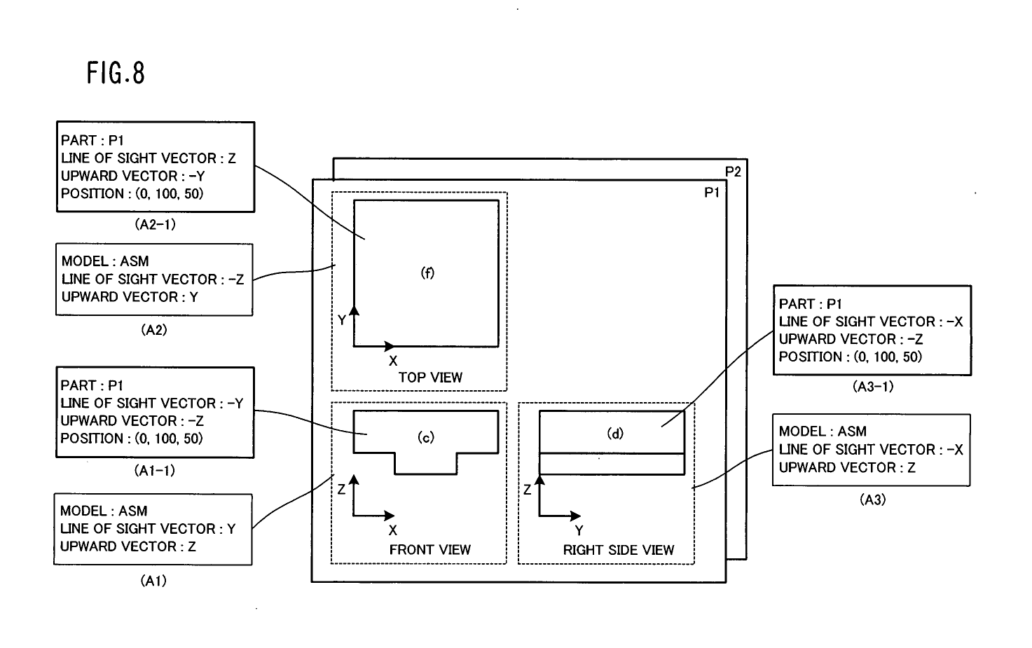

After generating shape data, the associative setting processing portion 164 sets the associative relationship in Step #110. Namely, grouping of the two-dimensional elements is performed for each part, and information as shown in FIG. 8 is added to the projection drawing again.

FIG. 8 shows an example of part information and projection information that are added to a projection drawing after a reprojection. As shown in FIG. 8, the projection information A1, A2 and A3 for the reprojection plus the part information A1-1, A2-1 and A3-1 are respectively added to the front view, the top view and the right side view of the projection. In this way, part information and projection information that were added to the projection before the reprojection are also added to the projection after the partial reprojection (the same information is added again).

As explained above, according to the partial reprojection method, device and a computer program of the present invention, a relationship between the coordinates of the assembly model and the coordinates of the part model, i.e., a projecting direction and a relative position of a part model in the coordinates of the assembly model can be specified from part information that was added as attributions. Therefore, it becomes easy to secure consistency between them. In addition, when correcting or updating a part drawing generated by projecting a three-dimensional model, if a model that was used for generating the projection is loaded, modification of all models is reflected on the projection. If a part of the models is loaded, only the shape thereof can be reflected without loading the model that was used for the projection. As a result, in a top-down design for example, it will be sufficient to pass minimum data in each stage from a concept design via a detail design through a whole check.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A partial reprojection method for reflecting a shape modified in a part model on a two-dimensional projection that is generated from an assembly model in a three-dimensional CAD system, the method comprising the steps of:
grouping elements projected from the assembly model for each part;
adding attributions of each part information to the two-dimensional projection, the attributions including a line of sight and a position of the part; and
specifying two-dimensional elements to be updated when updating the shape in the part model, so as to decide a projecting direction of the part model from the line of sight of each part included in the part information and to decide a generating position of the two-dimensional elements from the position of the part included in the part information.

2. A partial reprojection method according to claim 1, further comprising the steps of:
adding attributions of projection information to the two-dimensional projection, the attributions including information about a loaded model and information about a model to be projected; and
deciding whether the entire reprojection is performed from the assembly model or a partial reprojection is performed for a part in accordance with the projection information, wherein
if the partial reprojection is performed, the attributions of the part information and the projection information are not changed but only the shape is changed.

3. A partial reprojection device for reflecting a shape modified in a part model on a two-dimensional projection that is generated from an assembly model in a three-dimensional CAD system, the device comprising a reprojection processing portion for controlling a partial reprojection process and a modeling kernel for performing processes including a contour line process and a hidden line process, wherein the reprojection processing portion includes
an associative analysis processing portion for analyzing information of the two-dimensional projection to be reprojected;
a drawing processing portion for deciding three-dimensional elements to be projected in association with the modeling kernel from three-dimensional shape data and a projection condition;
a drawing data generation processing portion for generating the decided three-dimensional elements as two-dimensional elements on the drawing; and
an associative setting processing portion for grouping the generated two-dimensional elements for each part and for setting a relationship with conditions and the models.

4. A computer program product for use in a three-dimensional CAD system for enabling reflection of a shape modified in a part model on a two-dimensional projection generated from an assembly model, the computer program product comprising:
means for grouping elements projected from the assembly model for each part;
means for adding attributions of each part information to the two-dimensional projection, the attributions including a line of sight and a position of the part; and
means for specifying two-dimensional elements to be updated when updating the shape in the part model, so as to decide a projecting direction of the part model from the line of sight of each part included in the part information and to decide a generating position of the two-dimensional elements from the position of the part included in the part information.

5. The computer program product according to claim 4, further comprising:
means for adding attributions of projection information to the two-dimensional projection, the attributions including information about a loaded model and information about a model to be projected;
means for deciding whether the entire reprojection is performed from the assembly model or a partial reprojection is performed for a part in accordance with the projection information; and
means for changing only the shape without changing the attributions of the part information and the projection information when performing the partial reprojection.

6. A recording medium that can be read by a computer and stores a computer program for a three-dimensional CAD system that enables reflection of a shape modified in a part model on a two-dimensional projection generated from an assembly model, the computer program making a computer perform the process comprising the steps of:
grouping elements projected from the assembly model for each part;
adding attributions of each part information to the two-dimensional projection, the attributions including a line of sight and a position of the part; and
specifying two-dimensional elements to be updated when updating the shape in the part model, so as to decide a projecting direction of the part model from the line of sight of each part included in the part information and to decide a generating position of the two-dimensional elements from the position of the part included in the part information.

7. The recording medium according to claim 6, wherein the process performed by the computer further comprising the steps of:
adding attributions of projection information to the two-dimensional projection, the attributions including information about a loaded model and information about a model to be projected;
deciding whether the entire reprojection is performed from the assembly model or a partial reprojection is performed for a part in accordance with the projection information; and
changing only the shape without changing the attributions of the part information and the projection information when performing the partial reprojection.
